(19) United States
(12) Patent Application Publication
(10) Pub. No.: US 2025/0008093 A1
(43) Pub. Date: Jan. 2, 2025

(54) METHOD AND APPARATUS FOR VIDEO CODING USING INTRA MIRROR PREDICTION

(71) Applicants: HYUNDAI MOTOR COMPANY, SEOUL (KR); KIA CORPORATION, SEOUL (KR); KWANGWOON UNIVERSITY INDUSTRY-ACADEMIC COLLABORATION FOUNDATION, SEOUL (KR)

(72) Inventors: Dong Gyu Sim, Seoul (KR); Min Hun Lee, Uijeongbu-si (KR); Joo Hyung Byeon, Seoul (KR); Jin Heo, Yongin-si (KR); Seung Wook Park, Yongin-si (KR)

(73) Assignees: HYUNDAI MOTOR COMPANY, SEOUL (KR); KIA CORPORATION, SEOUL (KR); KWANGWOON UNIVERSITY INDUSTRY-ACADEMIC COLLABORATION FOUNDATION, SEOUL (KR)

(21) Appl. No.: 18/884,703

(22) Filed: Sep. 13, 2024

Related U.S. Application Data
(63) Continuation of application No. PCT/KR2023/003478, filed on Mar. 15, 2023.

(30) Foreign Application Priority Data
Mar. 28, 2022 (KR) 10-2022-0038330
Mar. 14, 2023 (KR) 10-2023-0033381

(51) Int. Cl. H04N 19/11; H04N 19/119; H04N 19/159; H04N 19/167; H04N 19/176; H04N 19/46; H04N 19/593

(52) U.S. Cl. CPC H04N 19/11; H04N 19/119; H04N 19/159; H04N 19/167; H04N 19/176; H04N 19/46; H04N 19/593

(57) ABSTRACT

A video decoding device obtains mirror prediction information for a target block and performs a mirror prediction on the target block based on the mirror prediction information. When the target block is part of a current block to be decoded, the video decoding device derives a mirror prediction boundary based on a mirror prediction type for determining a mirror prediction region and a non-mirror prediction region within the current block. The video decoding device predicts the mirror prediction region based on the mirror prediction boundary, predicts the non-mirror prediction region and thereby predicts the current block.

### CROSS REFERENCE TO RELATED APPLICATIONS

This application is a continuation of International Application No. PCT/KR2023/003478 filed on Mar. 15, 2023, which claims priority to and the benefit of Korean Patent Application No. 10-2022-0038330 filed on Mar. 28, 2022, and Korean Patent Application No. 10-2023-0033381, filed on Mar. 14, 2023, the entire contents of each of which are incorporated herein by reference.

### TECHNICAL FIELD

The present disclosure relates to a video coding method and an apparatus using intra mirror prediction.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required. In particular, there is a need for techniques that efficiently utilize previously reconstructed information for intra prediction of the current block.

### SUMMARY

The present disclosure seeks to provide a video coding method and an apparatus that, in an intra prediction of a current block, perform a prediction or a prediction/reconstruction on a portion of the current block. To increase video coding efficiency and enhance video quality, the video coding method and the apparatus perform a mirror prediction or reconstruction on the remaining portion of the current block.

At least one aspect of the present disclosure provides a method performed by a video decoding device for predicting a target block. The method includes obtaining mirror prediction information for the target block, and performing a mirror prediction on the target block based on the mirror prediction information. When the target block is part of a current block to be decoded, in preparation for determining a mirror prediction region and a non-mirror prediction region within the current block, the method further includes deriving a mirror prediction boundary based on a mirror prediction type that indicates a first type or a second type. Here, the first type is established by the mirror prediction region including a first region and a second region that are contiguous about the mirror prediction boundary. The second type is established by the mirror prediction region including the first region and the second region that are present at opposite ends of the current block with a gap between the first region and the second region. The target block is one of the first region and the second region.

Another aspect of the present disclosure provides a method performed by a video encoding device for predicting a target block. The method includes setting mirror prediction information for the target block, and performing a mirror prediction on the target block based on the mirror prediction information. When the target block is part of a current block to be encoded, in preparation for determining a mirror prediction region and a non-mirror prediction region within the current block, the method further includes deriving a mirror prediction boundary based on a mirror prediction type that indicates a first type or a second type. Here, the first type is established by the mirror prediction region including a first region and a second region that are contiguous about the mirror prediction boundary. The second type is established by the mirror prediction region including the first region and the second region that are present at opposite ends of the current block with a gap between the first region and the second region. The target block is one of the first region and the second region.

Yet another aspect of the present disclosure provides a computer-readable recording medium storing a bitstream generated by a video encoding method. The video encoding method includes obtaining mirror prediction information for a target block. The video encoding method also includes performing a mirror prediction on the target block based on the mirror prediction information.

As described above, the present disclosure provides a video coding method and an apparatus that, in an intra prediction of a current block, perform a prediction or a prediction/reconstruction on a portion of the current block, followed by a mirror prediction or reconstruction on the remaining portion of the current block. Thus, the video coding method and the apparatus increase video coding efficiency and enhance video quality.

### BRIEF DESCRIPTION OF THE FIGURES

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a detailed block diagram of a portion of a video decoding device according to at least one embodiment of the present disclosure.

FIG. 7 is a flowchart of a mirror prediction method according to at least one embodiment of the present disclosure.

FIG. 8 is a diagram illustrating a mirror prediction type according to at least one embodiment of the present disclosure.

FIG. 9 is a diagram illustrating a mirror prediction based on a first type according to at least one embodiment of the present disclosure.

FIG. 10 is a diagram illustrating a mirror prediction based on a first type according to another embodiment of the present disclosure.

FIG. 11 is a diagram illustrating a mirror prediction based on a second type according to another embodiment of the present disclosure.

FIG. 12 is a flowchart of a mirror prediction method according to another embodiment of the present disclosure.

FIG. 13 is a diagram illustrating the location of candidate block vectors around a region where a mirror prediction is performed.

FIG. 14 is a diagram illustrating the configuration of a template for mirror prediction.

FIG. 15 is a flowchart of a mirror prediction method according to yet another embodiment of the present disclosure.

FIG. 16 is a diagram illustrating a mirror prediction based on a first type according to yet another embodiment of the present disclosure.

FIG. 17 is a diagram illustrating a mirror prediction based on a second type according to yet another embodiment of the present disclosure.

FIG. 18 is a flowchart of a mirror prediction method performed by a video encoding device, according to at least one embodiment of the present disclosure.

FIGS. 19A and 19B are diagrams illustrating mirror prediction using template matching, according to another embodiment of the present disclosure.

FIG. 20 is a flowchart of a mirror prediction method performed by a video encoding device, according to another embodiment of the present disclosure.

FIG. 21 is a flowchart of a mirror prediction method performed by a video decoding device, according to another embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

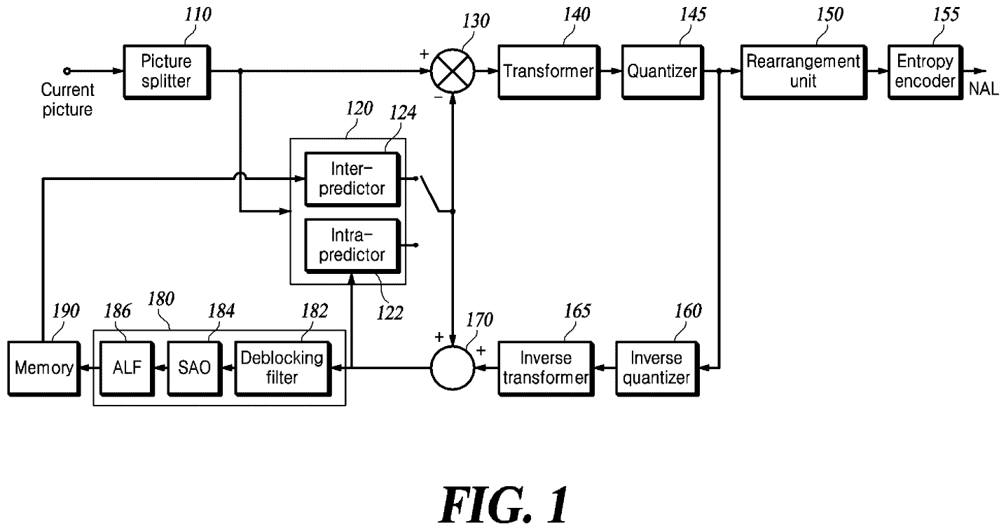

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

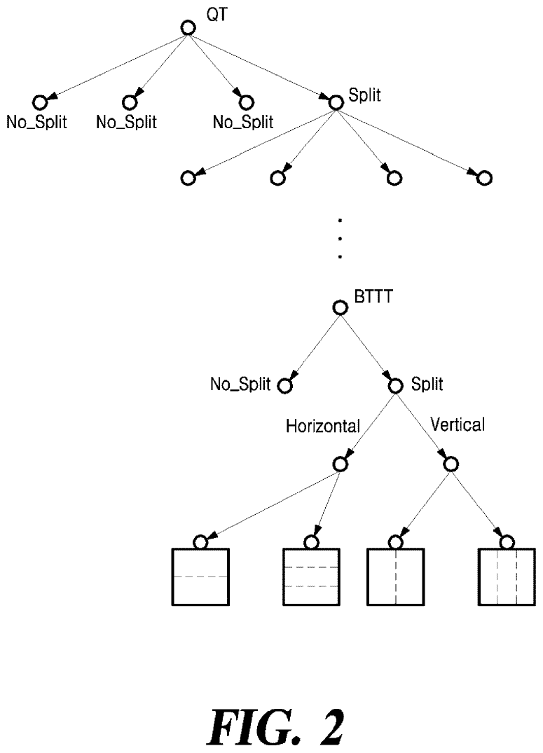

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

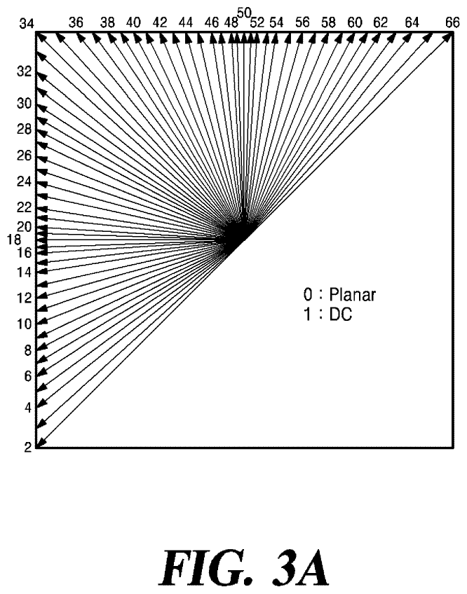

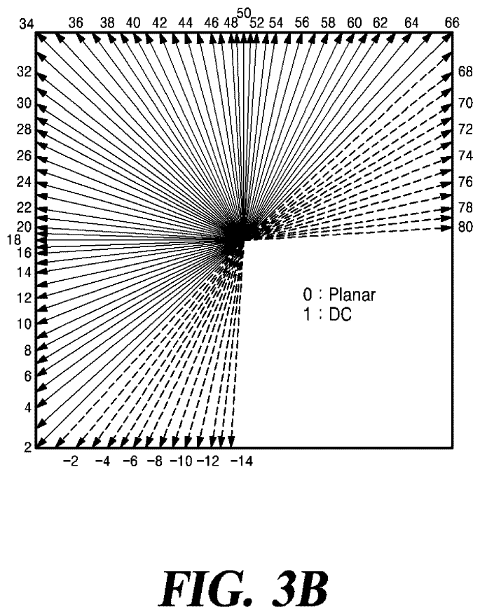

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

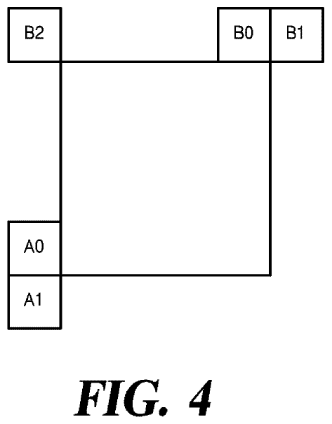

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

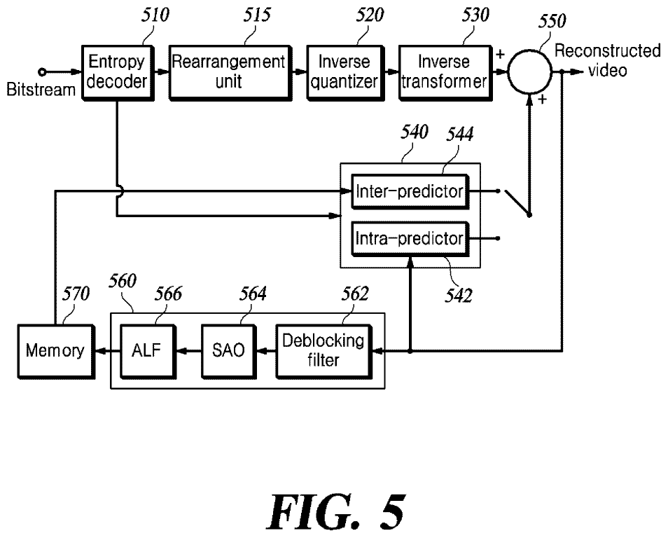

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that, in an intra prediction of the current block, perform a prediction or a prediction/reconstruction on a portion of the current block, followed by a mirror prediction or mirror reconstruction on the remaining portion of the current block.

The following embodiments may be performed by the predictor 120 in the video encoding device. The following embodiments may also be performed by the predictor 540 in the video decoding device.

The video encoding device in the intra prediction of the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the intra prediction of the current block.

In the following description, the term “target block” may be used interchangeably with the current block or coding unit (CU), or may refer to some area of a coding unit. Accordingly, the target block may be all or part of the current block to be encoded.

Further, the value of one flag being true indicates when the flag is set to 1. Additionally, the value of one flag being false indicates when the flag is set to 0.

### I. Intra Prediction

In the VVC (Versatile Video Coding) technique, the intra-prediction mode of the luma block has 65 subdivided directional modes (2 to 66) in addition to the non-directional modes (planar and DC), as illustrated in FIG. 3A. The 65 directional modes, planar, and DC, are collectively referred to as 67 intra-prediction modes (IPMs).

The Intra Block Copy (IBC) mode performs intra prediction of the current block by copying a reference block in the same frame by using a block vector to generate a prediction block of the current block.

The video encoding device performs block matching to derive an optimal block vector. Here, the block vector represents a displacement from the current block to the reference block. To improve coding efficiency, the video encoding device may separate the block vector into a block vector predictor (BVP) and a block vector difference (BVD), and encode and then may transmit the BVD and the BVP to the video decoding device instead of transmitting the block vector as a whole.

Hereinafter, the spatial resolution of the BVD is considered to be the same as that of the block vector.

As the IBC mode, there is a merge mode and an Advanced Motion Vector Prediction (AMVP) mode. As described above, in the merge mode, the merge index is parsed, and in the AMVP mode, the block vector index and BVD are parsed.

The following embodiments are described centering on the video decoding device, but may also be performed by the video encoding device as described above.

### II. Intra Mirror Prediction

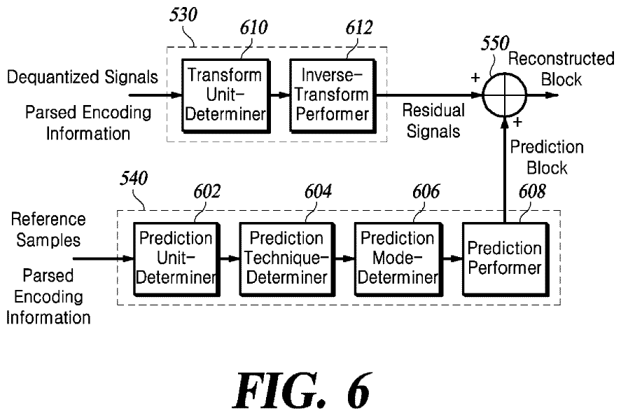

FIG. 6 is a detailed block diagram of a portion of the video decoding device according to at least one embodiment of the present disclosure.

The video decoding device according to the present embodiment may determine a prediction unit and a transform unit, and perform a prediction and an inverse transform on the current block corresponding to the determined unit by using the determined prediction technique and prediction mode, and finally generate a reconstructed block of the current block. As illustrated in FIG. 6, this may be performed in the video decoding device by an inverse transformer 530, a predictor 540, and an adder 550. Alternatively, the same operations as illustrated in FIG. 6 may be performed in the video encoding device by the inverse transformer 165, the picture splitter 110, the predictor 120, and the adder 170. In this case, the video decoding device uses encoding information parsed from the bitstream, while the video encoding device may use encoding information set from a higher level in terms of minimizing rate distortion. Hereinafter, for convenience, the present embodiment will be described centering on the video decoding device.

The predictor 540 as illustrated in FIG. 5 includes the intra predictor 542 and the inter predictor 544 depending on the prediction technique, whereas the predictor 540 as illustrated in FIG. 6 may include all or part of a prediction unit-determiner 602, a prediction technique-determiner 604, a prediction mode-determiner 606, and a prediction performer 608. The prediction unit-determiner 602 determines a prediction unit (PU). The prediction unit may be the current block or one subblock of the subblocks split from the current block. The prediction technique-determiner 604 determines a prediction technique for the prediction unit, such as intra prediction, inter prediction, or Intra Block Copy (IBC) prediction. The prediction mode-determiner 606 determines a detailed prediction mode for the prediction technology. The prediction performer 608 generates a prediction block of the current block according to the determined prediction mode.

The inverse transformer 530 includes a transform unit-determiner 610 and an inverse transform performer 612. The transform unit-determiner 610 determines a transform unit (TU) for the dequantized signals of the current block, and the inverse transform performer 612 inversely transforms the transform unit represented by the dequantized signals to generate residual signals.

The adder 550 sums the prediction block and the residual signals to generate a reconstructed block. The reconstructed block is stored in memory and may be subsequently used for the prediction of other blocks.

As described above, the prediction technique of the current block may be determined by the prediction technique-determiner 604. The prediction technique may be one of techniques such as inter prediction, intra prediction, IBC mode, mirror prediction mode, and the like.

As one example, if the current block is predicted according to the mirror prediction mode, the video encoding device may signal information on whether the mirror prediction is to be performed on the current block by signaling a one-bit flag (hereinafter referred to as the “mirror prediction flag”). The video decoding device may perform a mirror prediction on the current block by parsing the mirror prediction flag from the bitstream.

Here, the mirror prediction flips the reference block in a horizontal or vertical direction and then generates the flipped reference block as the prediction block.

Further, if the prediction technique of the current block is determined to be a mirror prediction mode, the video decoding device may parse the skip flag. If the skip flag is 1, the transform process may be omitted. In this case, if a region (hereinafter used interchangeably with “non-mirror prediction region” or “regular prediction region”) other than the region subject to the mirror prediction within the current block is predicted in template matching mode or IBC mode, and if the skip flag is 1, the transform process may be omitted for the entire region of the current block. On the other hand, if the non-mirror prediction region within the current block is predicted by using neighboring reference samples in the region, such as 67 IPMs, the transform process may be omitted for the region where the mirror prediction is performed (hereinafter used interchangeably with “mirror prediction region”).

In one example, if the prediction technique of the current block is determined to be the mirror prediction mode and a non-mirror prediction region within the current block is predicted in an IBC mode, a 1-bit flag may be signaled. In this case, the 1-bit flag may indicate whether merge mode or AMVP mode is to be applied to the current block.

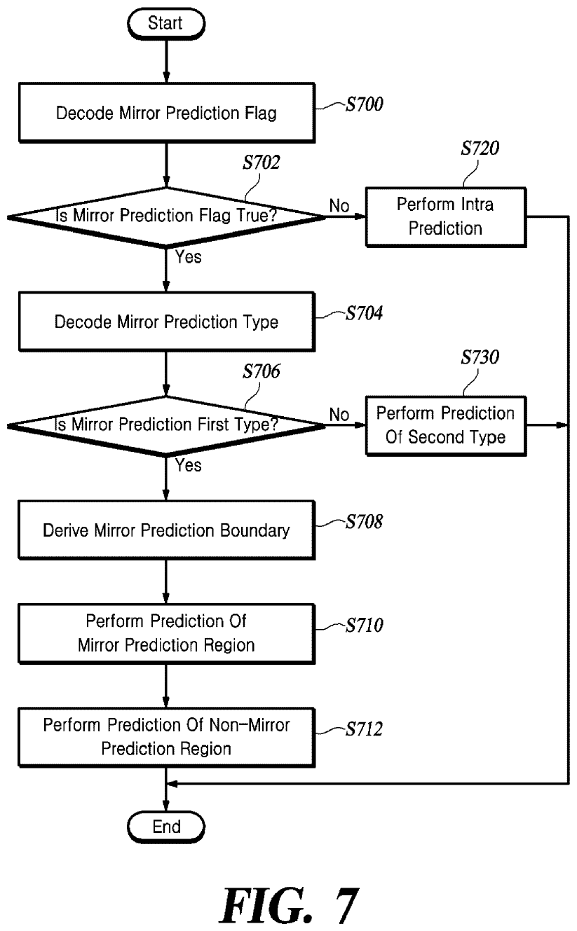

If the prediction technique of the current block is the mirror prediction mode, the mirror prediction may be performed by the video decoding device as shown in the flowchart of FIG. 7. In one example, the prediction mode-determiner 606 and the prediction performer 608 may perform steps according to the flowchart of FIG. 7.

FIG. 7 is a flowchart of a mirror prediction method according to at least one embodiment of the present disclosure.

The video decoding device decodes the mirror prediction flag indicating whether to perform a mirror prediction (S700), and then determines whether to perform the mirror prediction based on the mirror prediction flag (S702).

First, if the mirror prediction flag is false (No in S702), the video decoding device performs a regular intra prediction on the current block (S720). Here, the regular intra prediction may be a prediction based on the intra-prediction mode illustrated in FIG. 3A.

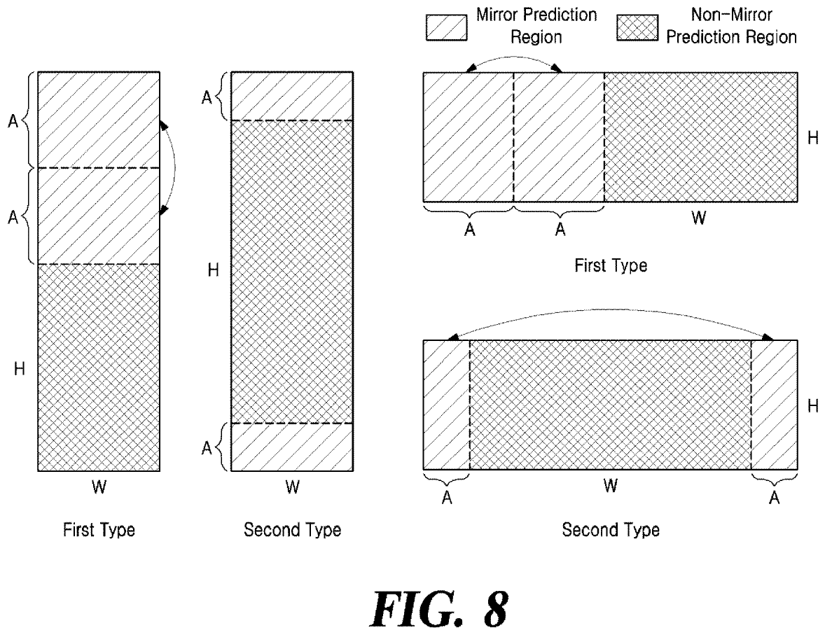

On the other hand, if the mirror prediction flag is true (Yes in S702), the video decoding device decodes the mirror prediction type from the bitstream (S704) and checks the mirror prediction type (S706). Here, the mirror prediction type indicates a first type or a second type. The first type and the second type are mirror prediction types defined according to a mirror prediction in a vertical or horizontal direction, as illustrated in FIG. 8. The first type is when the two regions (first region and second region) in the mirror prediction region are horizontally or vertically adjacent, and the second type is when the two regions exist at opposite ends of the current block (up and down or left and right) with a gap existing between the two regions. In the example of FIG. 8, A is information indicating the location of a boundary (hereinafter used interchangeably with “mirror prediction boundary”) at which a mirror prediction is performed. At this time, the minimum value of A may be determined according to the size W×H of the current block. Further, with regard to the maximum value of A, A≤H/2 is satisfied for a mirror prediction in the vertical direction and A≤W/2 is satisfied for a mirror prediction in the horizontal direction.

In one example, the mirror prediction type may be represented by a one-bit flag, the mirror prediction type flag. Accordingly, the video decoding device may decode the mirror prediction type flag and determine the mirror prediction type based on the value of the flag. For example, if the mirror prediction type flag is true, the mirror prediction type may be set to the first type, and if the mirror prediction type flag is false, the mirror prediction type may be set to the second type.

On the other hand, since the subsequent operations according to the mirror prediction type are similar, mirror prediction may be performed as in the case where the mirror prediction type is the first type, when the mirror prediction type is the second type (S730). Hereinafter, steps will be described where the video decoding device performs a mirror prediction when the first type is determined as the mirror prediction type (Yes in S706).

As one example, when the prediction mode of the current block is a mirror prediction mode, to distinguish a mirror prediction based on a horizontal or vertical boundary, the video decoding device may decode information indicating whether the mirror prediction is based on a horizontal or vertical boundary.

As another example, if the prediction mode of the current block of size W×H is mirror prediction mode, information indicative of whether the mirror prediction is based on a horizontal or vertical boundary may be implicitly determined as follows. First, if W>H, it may be determined that a mirror prediction based on the vertical boundary is performed, and if W≤H, it may be determined that a mirror prediction based on the horizontal boundary is performed.

On the other hand, since the operation of the mirror prediction based on the horizontal boundary or the vertical boundary is the same, the mirror prediction based on the horizontal boundary and the vertical boundary will be described comprehensively hereinafter.

The video decoding device derives a mirror prediction boundary (S708), performs a prediction for the mirror prediction region (S710), and then performs a prediction for the non-mirror prediction region (S712).

In one example, the video decoding device may decode the A value illustrated in FIG. 8 as information related to the location of the mirror prediction boundary.

As another example, if the current block has a size of W×H, the video decoding device may derive mirror prediction boundary information. The mirror prediction boundary information may be a preset boundary value if a mirror prediction is implicitly performed based on a vertical or horizontal boundary based on a relationship between W and H for the current block of size W×H, or if information indicating whether a mirror prediction is performed based on a vertical or horizontal boundary is decoded. For example, if mirror prediction is performed based on a horizontal boundary, the preset boundary value A may be H/4.

As another example, if mirror prediction is implicitly performed based on a vertical or horizontal boundary according to a relationship between W and H for a current block of size W×H, the current block may be divided into N (where N is a natural number) parts according to an aspect ratio of the current block, as shown in Table 1. Then, the video decoding device may decode information on a boundary-holding region that holds a boundary subject to the mirror prediction (hereinafter used interchangeably with “boundary-inclusive region”) among partitioned regions.

TABLE 1

| Aspect ratio (W:H) | N partitioning |
|---|---|
| 16:1 | 8 |
| 8:1 | 4 |
| 4:1 | 4 |
| 3:1 | 3 |
| 2:1 | 2 |
| 1:1 | 2 |
| 1:2 | 2 |
| 1:3 | 3 |
| 1:4 | 4 |
| 1:8 | 4 |
| 1:16 | 8 |

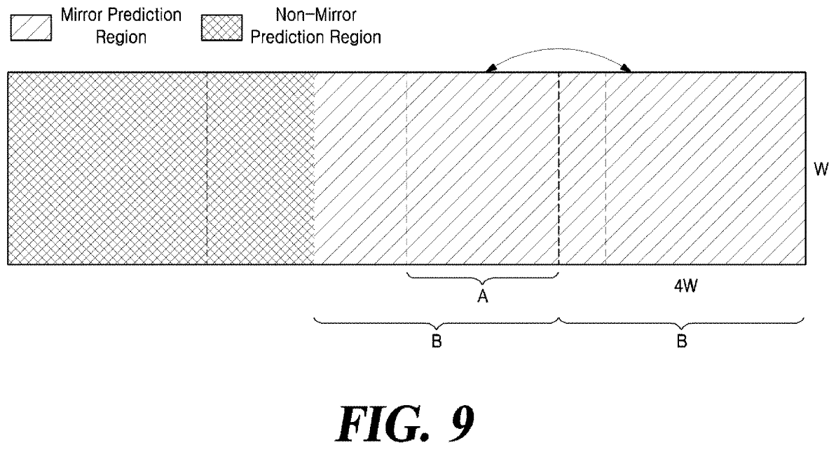

In one example, as illustrated in FIG. 9, when a mirror prediction is performed according to the first type, and the current block is implicitly N-partitioned according to the aspect ratio as shown in Table 1, the video decoding device may decode a region index and A for the boundary-inclusive region. The video decoding device may obtain information on the boundary at which the mirror prediction is performed by decoding the region index and A. In the example of FIG. 9, B is the size of the mirror prediction region (indicating a width in the horizontal mirror prediction and a height in the vertical mirror prediction), and A indicates the location of the mirror prediction boundary within the boundary-inclusive region.

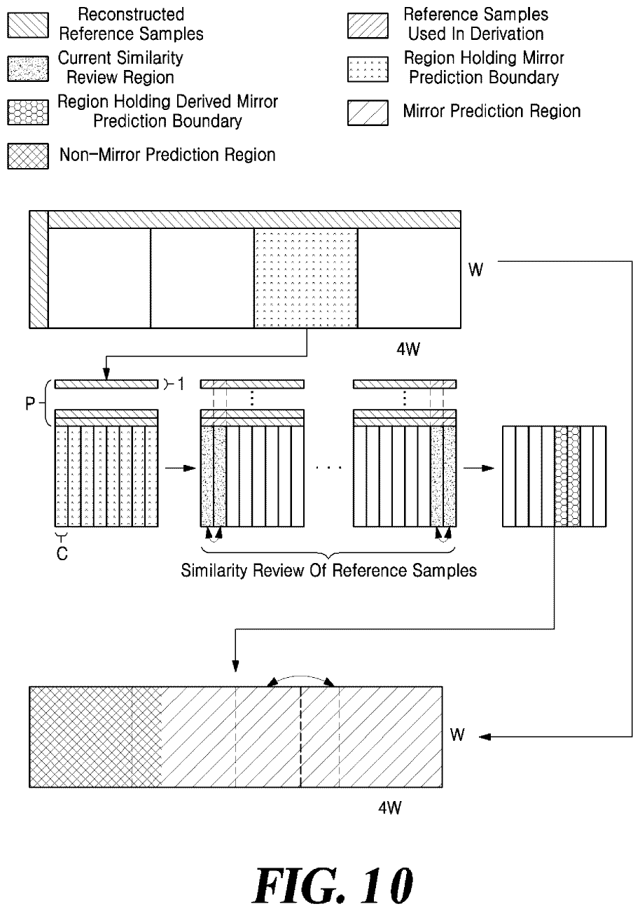

On the other hand, as illustrated in FIG. 10, when the current block is mirror-predicted based on the first type with respect to the vertical boundary, the current block is implicitly N-partitioned according to the aspect ratio, and the region index is parsed for the boundary-inclusive region holding the boundary subject to the mirror prediction, the video decoding device may evenly partition the boundary-inclusive region into size units of C, and may use the top P pieces of lines of the current block as reference samples to derive the mirror prediction boundary. For the samples on the top P lines of the region having a size of C, the video decoding device may flip the reference samples of one side with respect to the boundary of the two regions to check the similarity of the flipped reference samples with the reference samples of the other side and may derive the boundary containing the most similar regions as the mirror prediction boundary. The similarity may be calculated according to one of the following methods: Sum of Absolute Difference (SAD), Sum of Absolute Transformed Difference (SATD), and Sum of Squared Difference (SSD) between the regions. Furthermore, the number of top lines inclusive of the reference samples may be predefined in accordance with an arrangement between the video encoding device and the video decoding device. In this case, one or more lines may be utilized. When multiple lines are utilized, the video decoding device may decode an index indicating which line's reference samples are to be utilized. Size C may be predefined by an agreement between the video encoding device and the video decoding device based on the size of the current block. Further, C may be predefined by an agreement between the video encoding device and the video decoding device based on the size of the boundary-inclusive region.

As another example, when the current block is mirror-predicted based on the first type with respect to a horizontal boundary, the video decoding device may derive the mirror prediction boundary by utilizing the left P lines of the current block as reference samples.

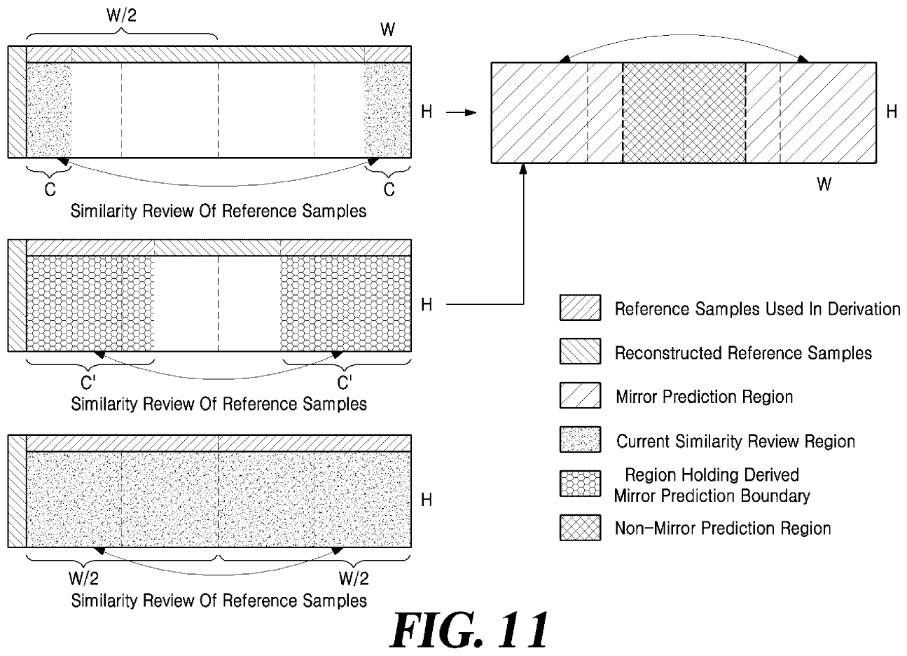

Further, as in the example of FIG. 11, when the current block is mirror-predicted based on the second type with respect to a vertical boundary, the video decoding device may derive the boundary subject to the mirror prediction by utilizing the top P lines of the current block as reference samples. For the equal regions of size C at opposite ends of the current block, the video decoding device may flip one or more lines of one side region of the opposite regions and may calculate the similarity between the opposite regions' reference samples to derive the boundary between the regions with the highest similarity as the boundary subject to the mirror prediction. In this case, C may be an integer value that is a multiple of 2, which falls between a minimum or absolute minimum determined by the current block's size and a maximum determined by the current block's size or W/2. Further, the similarity may be calculated according to any one of SAD, SATD, and SSD between regions. In the example of FIG. 11, a final mirror prediction boundary is derived based on three different C sizes.

In one example, if the current block is mirror-predicted based on the second type with respect to a horizontal boundary, the video decoding device may utilize the left P lines of the current block as reference samples to derive the boundary subject to the mirror prediction.

On the other hand, after deriving the information on the mirror prediction type of the current block and the region boundary where the mirror prediction is performed in the current block, the video decoding device may predict the region where the mirror prediction is performed as follows.

As an example, where a mirror prediction region coexists with a region in which a regular prediction is performed, i.e., a non-mirror prediction region, the video decoding device may perform the mirror prediction first, and then may perform the regular prediction.

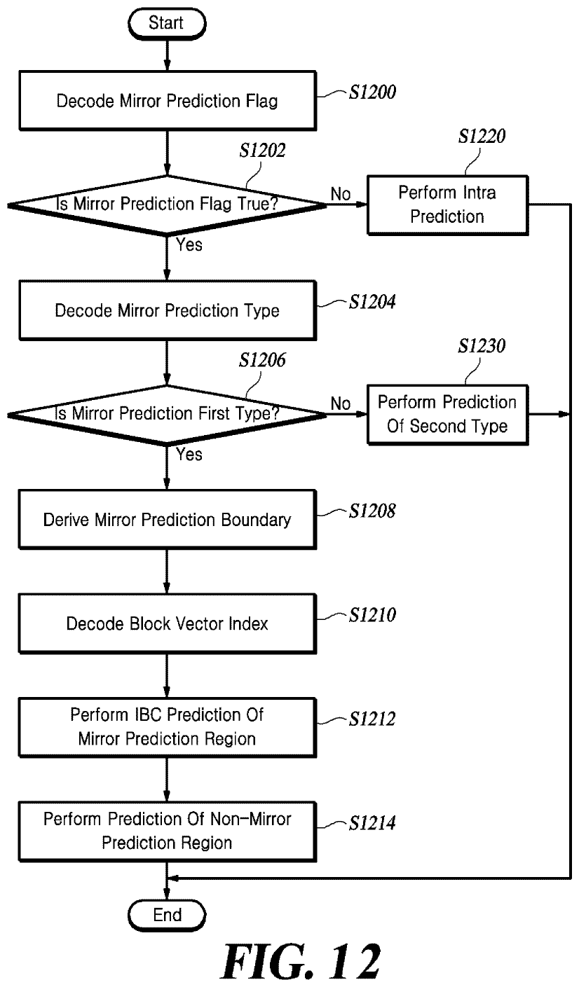

FIG. 12 is a flowchart of a mirror prediction method according to another embodiment of the present disclosure.

As described above, since the subsequent operations according to the mirror prediction type are similar, a mirror prediction may be performed as in the case where the mirror prediction type is the first type, when the mirror prediction type is the second type (S1230). Hereinafter, steps different from the flowchart of FIG. 7 will be described for the flowchart of FIG. 12.

As shown in the flowchart of FIG. 12, the video decoding device decodes a block vector index from the bitstream (S1210). After the block vector index is determined with respect to the current block by the video encoding device, the determined block vector index may be signaled to the video decoding device.

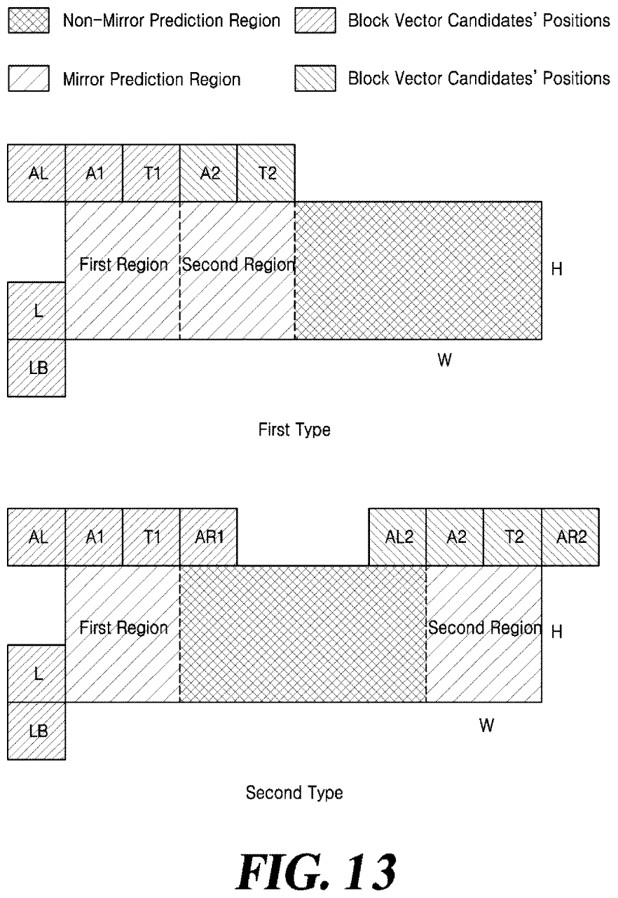

The video decoding device may predict by using the IBC mode based on the block vector index for one region at one end, and then may flip the one region to perform a mirror prediction for the remaining region (S1212). At this time, to compose a candidate list of block vectors according to the IBC prediction, the block vectors around the current block may be utilized as illustrated in FIG. 13. In other words, the video decoding device may derive a block vector from the candidate list by using the block vector index after composing the candidate list. Then, the video decoding device may use the block vector to predict one region between the first region and the second region from the previously reconstructed region in the current frame, and then may flip the predicted region to mirror-predict the other one between the first region and the second region.

Alternatively, the video decoding device may, after composing the candidate list, IBC-predict the first region according to the decoded block vector index, and then may flip the first region to mirror-predict the second region. Alternatively, the video decoding device may IBC-predict the second region and then may flip the second region to mirror-predict the first region.

For example, if the block vector indicated by the parsed block vector index is a block vector derived from a neighboring region of the first region (selected from AL, A1, T1, L, LB in the first type of FIG. 13, and selected from AL, A1, T1, AR1, L, LB in the second type of FIG. 13), the video decoding device may IBC-predict the first region and then may flip the first region to mirror-predict the second region.

Alternatively, if the block vector indicated by the parsed block vector index is a block vector derived from a neighboring region of the second region (selected from A2, T2 in the first type of FIG. 13, and selected from AL2, A2, T2, AR2 in the second type of FIG. 13), the video decoding device may IBC-predict the second region and then may flip the second region to mirror-predict the first region.

In one example, if the block vector indicated by the parsed block vector index is one of the History-based Block Vector Predictor (HBVP) candidates, the video decoding device may perform a prediction of a region closer to the region where the block vector was used, and then may flip to a region that is relatively farther away to perform a mirror prediction.

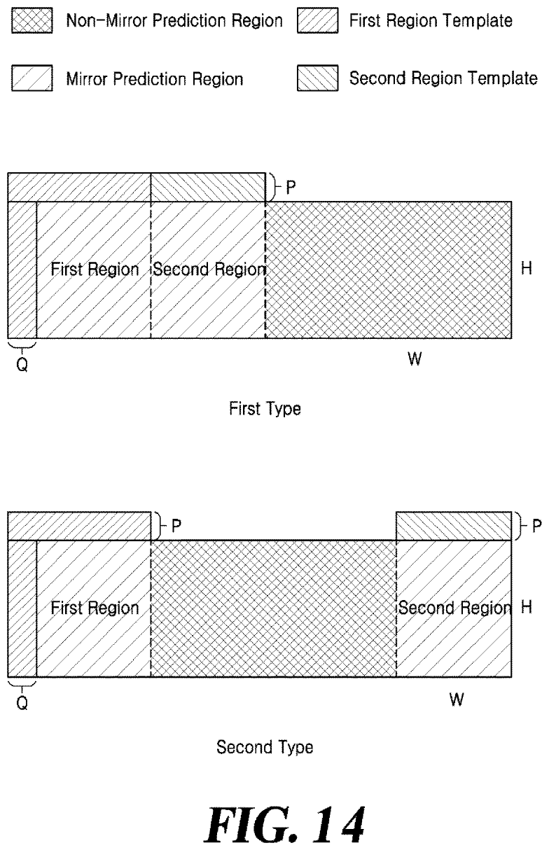

As another example, if the current block is to be mirror-predicted, the video decoding device may predict according to template matching for one region and then may flip one region to perform a mirror prediction for the other region. In this case, a template of each region for template matching may be configured for each region as illustrated in FIG. 14. In the example of FIG. 14, P represents the height of the template located at the top of the block, and Q represents the width of the template located at the left side of the block.

When template matching is performed by using the template of each region for the previously reconstructed regions in the current frame, the video decoding device calculates the similarity between the template of the first region and the template of the template-matched block by using the template of the first region, and the similarity between the templates of the second region and the templates of the template-matched block by using the template of the second region. Then, the video decoding device may perform a prediction based on the template matching for the region having the higher similarity, and may perform a mirror prediction by flipping the region predicted based on the template matching for the other region.

In this case, the similarity may be calculated according to one of SAD, SATD, and SSD between the regions. Since the templates of the two regions may have different widths, the values of the similarity functions may be normalized and then compared.

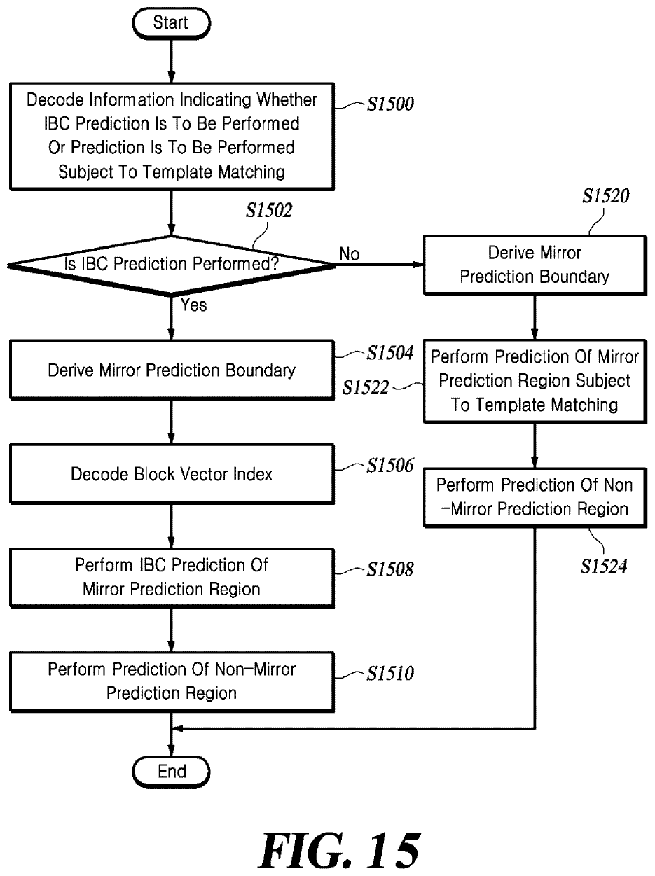

FIG. 15 is a flowchart of a mirror prediction method according to yet another embodiment of the present disclosure.

In the example of FIG. 15, the steps of decoding the mirror prediction flag and decoding the mirror prediction type are the same as in the example of FIG. 7, and are therefore omitted for convenience. The example of FIG. 15 illustrates a mirror prediction method based on the first type. Hereinafter, steps different from the flowchart of FIG. 12 will be described for the flowchart of FIG. 15.

In one example, as shown in the flowchart of FIG. 15, the video decoding device decodes information indicating whether to perform an IBC prediction or a prediction based on template matching for the mirror prediction region (S1500) and then verifies the information (S1502).

In the case of IBC prediction (Yes in S1502), the video decoding device may, after decoding the block vector index (S1506), predict by using the IBC mode based on the block vector index for one region, and then may flip one region to perform a mirror prediction for the other region (S1508).

On the other hand, in the case of prediction based on template matching (No in S1502), the video decoding device may make a prediction based on template matching for one region and then may flip one region to perform a mirror prediction for the other region (S1522).

In one example, information indicating whether to perform an IBC prediction or a prediction based on template matching for the mirror prediction region may be determined according to an agreement between the video decoding device and the video decoding device.

In one example, when a mirror prediction region and a region where a regular prediction is performed (i.e., a non-mirror prediction region) coexist in the current block, and the mirror prediction is performed first and the regular prediction is performed second, the video decoding device may perform entropy decoding and dequantizing on the current block to reconstruct the residual signals, perform a mirror prediction to reconstruct the mirror prediction region, and then may perform a prediction on the regular prediction region.

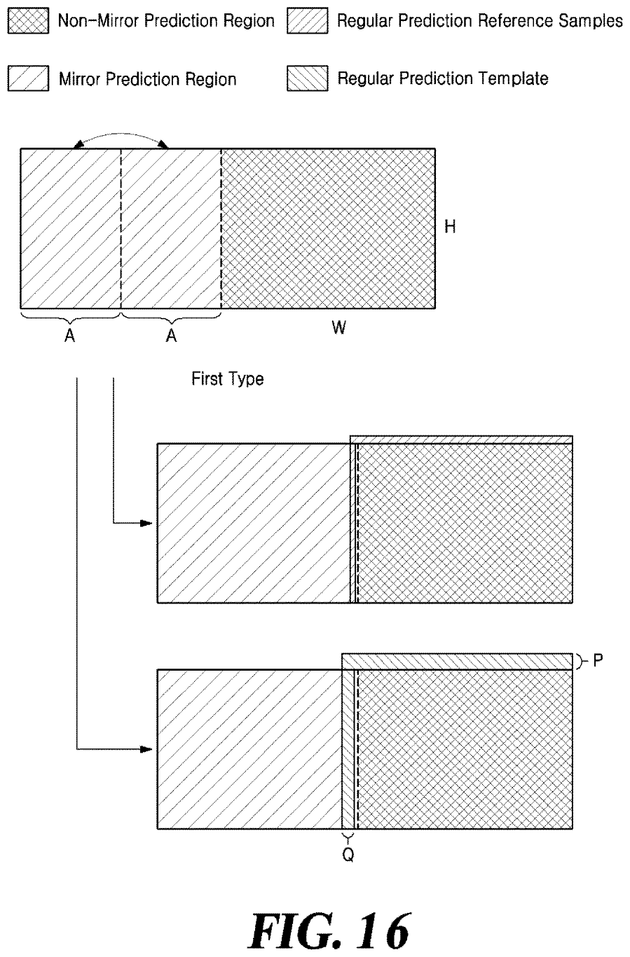

In one example, if the mirror prediction is performed based on the first type, the video decoding device may, after performing the mirror prediction, organize reference samples of the region for which the regular prediction is performed by using the information on the reconstructed region, as illustrated in FIG. 16. If the regular prediction utilizes prediction based on template matching, the video decoding device may form a template region, as illustrated in FIG. 16. In the example of FIG. 16, P represents a height of the template located at the top of the block, and Q represents a width of the template located at the left side of the block.

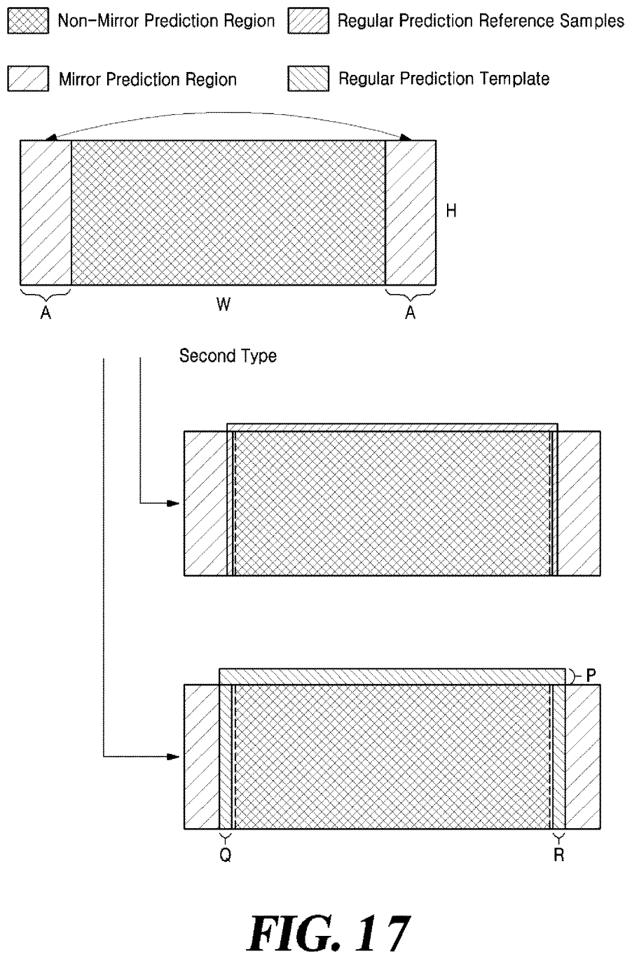

In one example, when the mirror prediction is performed based on the second type, the video decoding device may, after performing the mirror prediction as illustrated in FIG. 17, utilize the information on the reconstructed region to organize reference samples of the region for which the regular prediction is performed. If the regular prediction utilizes prediction based on template matching, the video decoding device may form a template region, as illustrated in FIG. 17. In the example of FIG. 17, P represents a height of the template located at the top of the block, Q represents a width of the template located at the left side of the block, and R represents a width of the template located at the right side of the block.

In one example, after prediction is performed for the mirror prediction region, a fixed mode may be used as the prediction mode for the region where regular prediction is performed, based on an agreement between the video encoding device and the video decoding device.

In one example, after prediction is performed for the mirror prediction region, the video decoding device may derive and use one prediction mode from among intra-prediction modes derived from previously reconstructed regions around the region as the prediction mode of the region where regular prediction is performed. In some embodiments, the prediction mode may be derived based on the directionality of the previously reconstructed region.

In one example, after the prediction is performed for the mirror prediction region based on the first type, the video decoding device may derive and use one prediction mode among the intra-prediction modes derived from the previously reconstructed region around the region as the prediction mode of the region in which the regular prediction is performed. When prediction is performed for the mirror prediction region based on the second type, the video decoding device may perform prediction based on template matching based on the previously reconstructed region for the region for which regular prediction is performed.

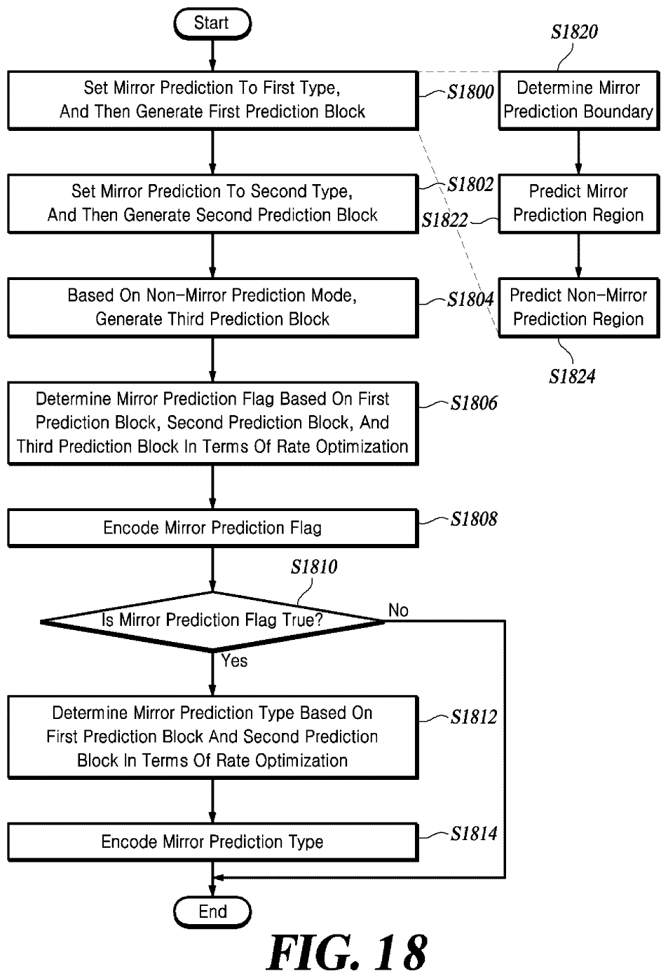

Hereinafter, a method for the video encoding device to perform a mirror prediction of the current block will be described by using the flowchart illustrated in FIG. 18. The flowchart illustrated in FIG. 18 corresponds to the flowchart illustrated in FIG. 7, FIG. 12, or FIG. 15.

FIG. 18 is a flowchart of a mirror prediction method performed by the video encoding device, according to at least one embodiment of the present disclosure.

The video encoding device sets the mirror prediction type of the current block to the first type and then generates the first prediction block by mirror-predicting the current block (S1800).

The video encoding device sets the mirror prediction type of the current block to the second type and then generates the second prediction block by mirror-predicting the current block (S1802).

Here, the first type is a case where the first region and the second region in the mirror prediction region are adjacent with respect to the mirror prediction boundary, and the second type is a case where the first region and the second region exist at opposite ends of the current block with a gap between the first region and the second region.

The first prediction block and the second prediction block may be generated according to the following steps (S1820 to S1824).

The video encoding device determines a mirror prediction boundary based on the mirror prediction type to determine a mirror prediction region and a non-mirror prediction region within the current block (S1820).

The video encoding device predicts the mirror prediction region based on the mirror prediction boundary (S1822).

The video encoding device predicts a non-mirror prediction region (S1824).

The video encoding device then generates a third prediction block of the current block based on the non-mirror prediction mode (S1804). Here, the non-mirror prediction mode may be the intra-prediction mode, the IBC mode, or template matching illustrated in FIG. 3A.

The video encoding device determines a mirror prediction flag in terms of rate distortion optimization based on the first prediction block, the second prediction block, and the third prediction block (S1806). Here, the mirror prediction flag indicates whether to perform a mirror prediction for the current block. For example, the video encoding device may determine the mirror prediction flag to be true if the third prediction block is not optimal, and determine the mirror prediction flag to be false if the third prediction block is optimal.

The video encoding device encodes the mirror prediction flag (S1808).

The video encoding device checks the mirror prediction flag (S1810).

If the mirror prediction flag is true (Yes in S1810), the video encoding device selects one prediction block in terms of rate-distortion optimization based on the first prediction block and the second prediction block and determines a mirror prediction type based on the selected prediction block (S1812). For example, the video encoding device may determine the mirror prediction type as a first type if the first prediction block is optimal, and determine the mirror prediction type as a second type if the second prediction block is optimal.

The video encoding device encodes the mirror prediction type (S1814).

The foregoing refers to a case where the target block to be mirror-predicted is part of the current block to be encoded/decoded. Hereinafter, the case where the target block is all of the current block is described.

As an example, the current block may be mirror-predicted according to the IBC mode. After flipping the original block, the video encoding device performs block vector search and residual calculation. Accordingly, the video encoding device may generate a prediction block without mirroring. The video decoding device may obtain the reference block by using the parsed block vector, and then may flip the reference block to generate a mirrored prediction block. At this time, the block vector may be searched according to the IBC mode.

For such mirror prediction, a horizontal flip and a vertical flip may be used. Hereinafter, the flip type indicates either a horizontal flip or a vertical flip. Further, a flip type flag is a flag indicating a flip type.

In the case where the target block is all of the current block, a mirror prediction flag may be signaled from the video encoding device to the video decoding device to indicate whether the mirror prediction of the current block is to be made.

In the case of IBC AMVP mode, the mirror prediction flag and the flip type flag are signaled. On the other hand, in the case of IBC merge mode, the video decoding device may derive the flip type flag from neighboring blocks.

For the IBC mode, the current block and the reference block may be aligned in a horizontal direction or a vertical direction depending on the flip type. Thus, in the case of a horizontal flip, the video encoding device may not signal the vertical component of the block vector, and the video decoding device may infer the vertical component of the block vector to be zero. Further, in the case of a vertical flip, the video encoding device may not signal the horizontal component of the block vector, and the video decoding device may infer the horizontal component of the block vector to be zero.

As another example, the current block may be mirror-predicted according to the template matching mode. The video encoding device and the video decoding device search for a template that is most similar to the current flipped template in a predetermined search area. At this time, a flip in the horizontal direction and a flip in the vertical direction may be used.

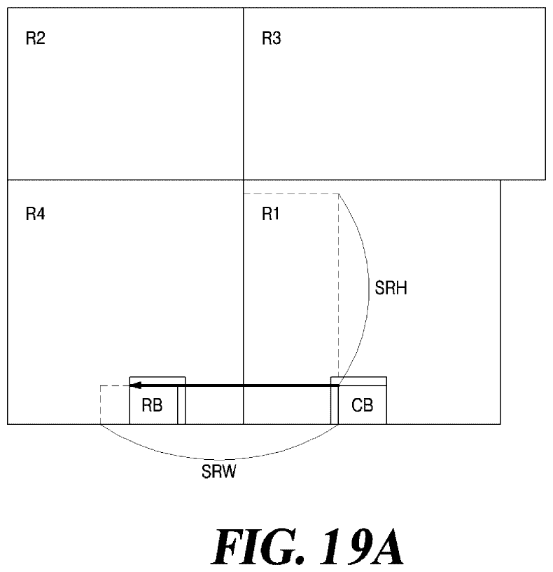

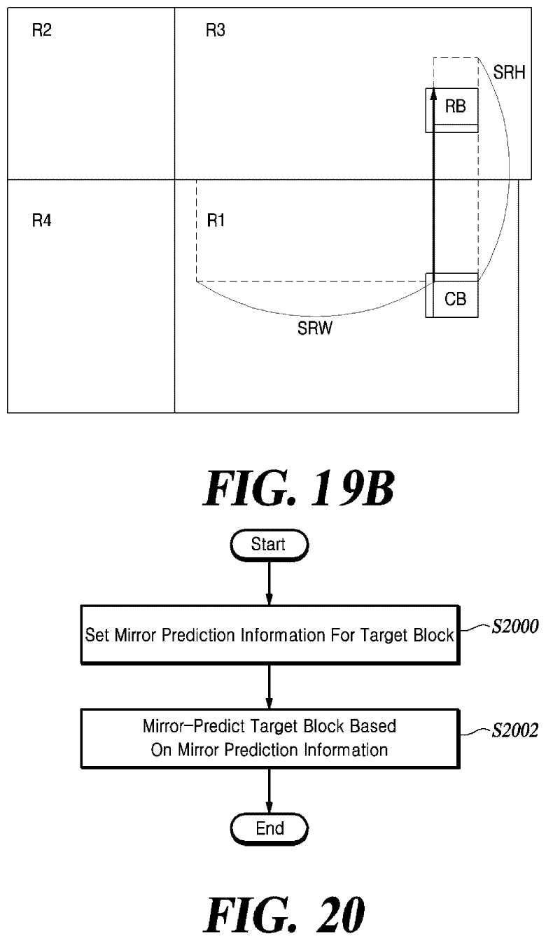

On the other hand, compared to conventional template matching, the search area of template matching for mirror prediction is limited. In the case of a horizontal flip, a part (R1) of the current CTU and a region (R4) to the left of the current block are searched, as illustrated in FIG. 19A. In the case of a vertical flip, a part (R1) of the current CTU and the top region (R3) of the current block are searched. At this time, the size of the search area, that is, the width (SRW) and height (SRH) of the search area may be set in proportion to the size of the current block. In the examples of FIGS. 19A and 19B, CB represents the current block and RB represents the reference block.

For template matching, the current block and the reference block may be aligned according to the flip type. For a horizontal flip, the vertical component of the block vector of the current block is set to the vertical component of the block vector of the neighboring block. For a vertical flip, the horizontal component of the block vector of the current block is set to the horizontal component of the block vector of the neighboring block.

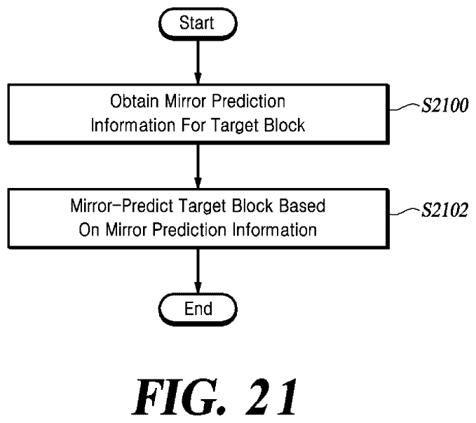

Referring now to FIGS. 20 and 21, a method of mirror-predicting the current block when the target block is all or part of the current block is described.

FIG. 20 is a flowchart of a mirror prediction method performed by the video encoding device, according to another embodiment of the present disclosure.

The video encoding device sets the mirror prediction information for the target block (S2000).

When the target block is all of the current block to be encoded, the video encoding device sets the block vector and flip type of the current block as mirror prediction information. At this time, the block vector may be set according to IBC mode or template matching. The flip type is a horizontal flip or a vertical flip, which may be indicated by the flip type flag. The block vector and flip type flag may be set in terms of rate-distortion optimization.

When the target block is part of the current block, the video encoding device sets a mirror prediction boundary as mirror prediction information according to the flowchart illustrated in FIG. 18. The mirror prediction boundary may be set in terms of rate distortion optimization.

The video encoding device mirror-predicts the target block based on the mirror prediction information (S2002).

When the target block is all of the current block, the video encoding device generates a prediction block of the current block based on the flip type and the block vector and then flips the generated prediction block. Further, the video encoding device may encode the block vector and flip type based on the mirror prediction result.

When the target block is part of the current block, the video encoding device performs a mirror prediction of the current block according to the flowchart illustrated in FIG. 18. Further, using the mirror prediction result, the video encoding device determines a mirror prediction flag and a mirror prediction type and encodes the mirror prediction flag and the mirror prediction type.

FIG. 21 is a flowchart of a mirror prediction method performed by the video decoding device, according to another embodiment of the present disclosure.

The video decoding device obtains mirror prediction information for the target block (S2100).

When the target block is all of the current block to be decoded, the video decoding device obtains the block vector and flip type of the current block as mirror prediction information. At this time, the block vector may be decoded or derived according to the IBC mode. Alternatively, the block vector may be derived according to template matching. The flip type may be parsed from the bitstream or may be derived from neighboring blocks.

When the target block is part of the current block, the video decoding device decodes the mirror prediction flag and mirror prediction type according to the flowchart illustrated in FIG. 7, FIG. 12, or FIG. 15, and then derives the mirror prediction boundary.

The video decoding device mirror-predicts the target block based on the mirror prediction information (S2102).

When the target block is all of the current block, the video decoding device generates a prediction block of the current block based on the block vector and the flip type and then flips the generated prediction block.

When the target block is part of the current block, the video decoding device performs a mirror prediction of the current block based on the mirror prediction boundary according to the flowchart illustrated in FIG. 7, FIG. 12, or FIG. 15.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

1. A method performed by a video decoding device for predicting a target block, the method comprising:
obtaining mirror prediction information for the target block; and
performing a mirror prediction on the target block based on the mirror prediction information;
wherein, when the target block is all of a current block to be decoded:
obtaining the mirror prediction information comprises obtaining a block vector of the current block as the mirror prediction information; and
performing the mirror prediction comprises generating a prediction block of the current block based on the block vector, and then flipping the prediction block.

2. The method of claim 1, wherein, when the target block is part of a current block to be decoded, obtaining the mirror prediction information comprises:
in preparation for determining a mirror prediction region and a non-mirror prediction region within the current block, deriving a mirror prediction boundary based on a mirror prediction type that indicates a first type or a second type, wherein the first type is established by the mirror prediction region including a first region and a second region that are contiguous about the mirror prediction boundary and the second type is established by the mirror prediction region including the first region and the second region that are present at opposite ends of the current block with a gap between the first region and the second region, and wherein the target block is one of the first region and the second region.

3. The method of claim 2, further comprising:
decoding from a bitstream a flag indicative of the mirror prediction type, and determining the mirror prediction type based on the flag.

4. The method of claim 3, further comprising:
decoding, from the bitstream, a mirror prediction flag indicating whether a mirror prediction is to be performed for the current block; and
checking the mirror prediction flag;
wherein, if the mirror prediction flag is true, the method further comprises:
decoding the flag indicative of the mirror prediction type.

5. The method of claim 2, wherein obtaining the mirror prediction information comprises
decoding information indicative of a location of the mirror prediction boundary.

6. The method of claim 2, wherein, when the mirror prediction type indicates the first type, obtaining the mirror prediction comprises:
partitioning the current block into a natural number N of regions according to an aspect ratio; and
decoding a region index indicative of a boundary-inclusive region among the N regions;
wherein the boundary-inclusive region is a region that holds the mirror prediction boundary.

7. The method of claim 6, wherein obtaining the mirror prediction further comprises:
decoding information indicative of a location of the mirror prediction boundary within the boundary-inclusive region.

8. The method of claim 2, wherein performing the mirror prediction comprises:
predicting the mirror prediction region based on the mirror prediction boundary; and
predicting the non-mirror prediction region.

9. The method of claim 8, wherein predicting the mirror prediction region comprises:
predicting one region of the first region and the second region by using a non-mirror prediction mode that is an intra-prediction mode, an Intra Block Copy mode (IBC mode), or a template matching mode; and
performing the mirror prediction on the target block by flipping the one region having been predicted.

10. A method performed by a video encoding device for predicting a target block, the method comprising:
setting mirror prediction information for the target block; and
performing a mirror prediction on the target block based on the mirror prediction information;
wherein, when the target block is all of a current block to be decoded:
setting the mirror prediction information comprises setting a block vector of the current block as the mirror prediction information; and
performing the mirror prediction comprises generating a prediction block of the current block based on the block vector, and then flipping the prediction block.

11. The method of claim 10, wherein, when the target block is part of a current block to be encoded, setting the mirror prediction information comprises:
in preparation for determining a mirror prediction region and a non-mirror prediction region within the current block, deriving a mirror prediction boundary based on a mirror prediction type that indicates a first type or a second type, wherein the first type is established by the mirror prediction region including a first region and a second region that are contiguous about the mirror prediction boundary and the second type is established by the mirror prediction region including the first region and the second region that are present at opposite ends of the current block with a gap between the first region and the second region, and wherein the target block is one of the first region and the second region.

12. The video encoding method of claim 11, wherein performing the mirror prediction comprises:
generating a first prediction block by setting the mirror prediction type to the first type, and then performing the mirror prediction on the current block; and
generating a second prediction block by setting the mirror prediction type to the second type, and then performing the mirror prediction on the current block.

13. The video encoding method of claim 12, further comprising:
generating a third prediction block of the current block based on a non-mirror prediction mode that is an intra-prediction mode, an Intra Block Copy mode (IBC mode), or a template matching mode;
determining a mirror prediction flag in terms of rate-distortion optimization based on the first prediction block, the second prediction block, and the third prediction block, the mirror prediction flag indicating whether the mirror prediction is to be performed for the current block; and
encoding the mirror prediction flag.

14. The video encoding method of claim 13, further comprising, when the mirror prediction flag is true:
selecting one prediction block in terms of the rate-distortion optimization from the first prediction block and the second prediction block, and determining the mirror prediction type based on a selected prediction block; and
encoding the mirror prediction type.

15. A computer-readable recording medium storing a bitstream generated by a video encoding method, the video encoding method comprising:
setting mirror prediction information for a target block; and
performing a mirror prediction on the target block based on the mirror prediction information;
wherein, when the target block is all of a current block to be decoded,
setting the mirror prediction information comprises setting a block vector of the current block as the mirror prediction information; and
performing the mirror prediction comprises generating a prediction block of the current block based on the block vector, and then flipping the prediction block.
